(19) United States
(12) Patent Application Publication
(10) Pub. No.: US 2024/0110935 A1
(43) Pub. Date: Apr. 4, 2024

(54) APPARATUS, SYSTEM, AND METHODS FOR HANDLING LABWARE

(71) Applicant: COASTAL GENOMICS, Burnaby (CA)

(72) Inventors: Ben Evers-Staples, Vancouver (CA); Yared Slobodan, Nanaimo (CA)

(21) Appl. No.: 18/032,506

(22) PCT Filed: Oct. 19, 2021
(86) PCT No.: PCT/IB2021/000714

§ 371 Date: Apr. 18, 2023

Related U.S. Application Data
(60) Provisional application No. 63/093,328, filed on Oct. 19, 2020.

(51) Int. Cl. G01N 35/10

(52) U.S. Cl. CPC G01N 35/10; G01N 2035/1051

(57) ABSTRACT

An apparatus configured to complementarily engage a pipetting head of a liquid handling system such that movement of the pipetting head effects a corresponding movement of the apparatus. The apparatus includes at least one engagement feature that is configured to mechanically and releasably engage a surface of a labware item as a means of releasably coupling the labware item to the apparatus. The labware item has at least one complementary engagement feature and optionally at least one release feature. With the labware item secured within a receptacle, the apparatus can translate relative to the labware item so that the engagement features of the apparatus are in engagement with the release features of the labware item, thereby permitting release of the labware item upon movement of the apparatus relative to the labware item.

### CROSS-REFERENCE TO RELATED APPLICATION

This application claims priority to and the benefit of the filing date of U.S. Provisional Patent Application No. 63/093,328, filed Oct. 19, 2020, which is incorporated herein by reference in its entirety.

### FIELD

This application relates to apparatuses, systems, and methods for handling labware. More particularly, in exemplary aspects, the application relates to apparatuses, systems, and methods that provide a passive mechanism for selectively engaging, positioning, and releasing a labware item within a liquid handling system.

### BACKGROUND

Reliable physical handling of labware is a critical component of laboratory automation, such as, for example, in the context of liquid handling robotics. Over the past several years, numerous mechanical and robotic solutions have been developed to address this need. However, each of these approaches suffers from one or more of the following deficiencies: insufficient actuation force to provide adequate gripping force in certain cases; insufficient contact to establish an adequate gripping force in certain cases; insufficient robustness of gripping mechanisms; an inability to work with labware of non-standard dimensions; and/or high cost and/or complexity.

Thus, there is a need for devices, systems, and methods that address one or more of these deficiencies of existing labware handling equipment.

### SUMMARY

Disclosed herein, in one aspect, is an apparatus having a body and a base. The body is configured for complementary engagement with a pipetting head of a liquid handling system such that movement of the pipetting head effects a corresponding movement of the apparatus. The base is coupled to the body. The base includes at least one engagement feature that is configured to mechanically engage a surface of a labware item to releasably couple the labware item to the apparatus.

Further disclosed herein are systems that include the apparatus in combination with a labware item having at least one engagement feature that is complementary to and configured to releasably mechanically engage a corresponding engagement feature of the at least one engagement feature of the apparatus.

Methods of using the apparatus are also disclosed. In various aspects, a method can include using a pipetting head of a liquid handling system to engage the apparatus. The method can further include using the pipetting head to position the apparatus relative to a labware item having at least one engagement feature that is complementary to a corresponding engagement feature of the at least one engagement feature of the apparatus. The apparatus can be positioned such that at least one engagement feature of the apparatus releasably engages a corresponding engagement feature of the at least one engagement feature of the labware item. With the apparatus releasably engaging the labware item, the method can further include using the pipetting head to selectively move the apparatus and the labware item.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1A is a perspective view of an exemplary apparatus having a body and a base as disclosed herein. As shown, the base includes at least one engagement feature. FIG. 1B is a bottom view of the apparatus of FIG. 1A.

FIG. 2A is a front elevational view of an exemplary labware item that includes at least one engagement feature and at least one release feature as disclosed herein. FIG. 2B is a rear elevational view of the labware item of FIG. 2A.

FIG. 3 is a perspective view of an exemplary system including an apparatus that releasably engages a labware item as disclosed herein.

FIGS. 4A-4I depict the sequential steps of a method of handling a labware item within a liquid handling system. FIG. 4A is an image depicting an apparatus, a labware item, a pipetting head, and a receptacle in a starting position. FIG. 4B is an image depicting the pipetting head in overlying relation to the apparatus. FIG. 4C is an image depicting the engagement between the mandrels of the pipetting head and the openings of the apparatus.

FIG. 4D is an image depicting the movement of the pipetting head (and the apparatus) after engagement between the pipetting head and the apparatus. FIG. 4E is an image depicting the engagement between the apparatus and the labware item, in response to downward movement of the pipetting head. FIG. 4F is an image depicting the movement of the pipetting head (and the labware item) after engagement between the apparatus and the labware item. FIG. 4G is an image depicting positioning of the labware item in overlying relation to the receptacle in response to movement of the pipetting head. FIG. 4H is an image depicting receipt of the labware item within the receptacle in response to downward movement of the pipetting head. FIG. 4I is an image depicting disengagement between the apparatus and the labware item in response to lateral translation and then vertical movement of the apparatus relative to the labware item.

FIG. 5 is a computing device for controlling the handling of a labware item as disclosed herein.

FIG. 6A is an image showing an exemplary system comprising an apparatus that is positioned for engaging a labware item as disclosed herein. FIG. 6B is an image showing the system of FIG. 6A, with the apparatus in engagement with the labware item. FIG. 6C is a front elevational view depicting an apparatus as shown in FIGS. 6A-6B. As shown, the apparatus can comprise one or more projections (e.g., posts) that are configured for receipt within corresponding slots of the labware item.

It should be understood that the drawings provided herein represent exemplary, non-limiting embodiments and are not necessarily to scale. Rather, the drawings are formatted to help aid the understanding of certain features disclosed herein. For example, the relative sizes of the depicted engagement and release features shown in the figures are not necessarily indicative of what would be seen in the liquid handling systems disclosed herein.

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a,” “an,” and “the” include plural references unless the context clearly dictates otherwise. Thus, for example, reference to “an engagement feature” includes one or more of such engagement features, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification. Thus, words denoting order, such as “first” or “next,” should be interpreted as optional aspects unless plain meaning or logic dictates otherwise.

Current labware handling approaches typically involve an actuated gripper mechanism that is designed to engage generic labware (e.g. microplates conforming to Society for Biomolecular Screening (SBS) standards), relying on the friction force between the gripper and the labware to hold onto the labware during movement operations. However, as discussed above, these gripper mechanisms typically have inadequate gripping force for certain applications, they are not capable of being easily modified to function with labware of non-standard dimensions, and they are often lead to undesirable costs or complexity (such as, for example, by increasing the number of components that must be independently controlled in a coordinated way to complete a labware handling process).

Other labware handling approaches include the use of magnetic attraction between a magnetized lifting mechanism and labware that has been modified to include a magnet. In addition to generating additional costs, these modifications render the approach incompatible with some liquid handling workflows, including magnetic bead DNA purification, while also requiring the use of a powered system for selectively minimizing the magnetization of the lifting mechanism and/or labware to permit disengagement.

Still other approaches to this problem include the use of a notched arm that is added on the instrument gantry and configured to mate with a metal platform that is engaged with a piece of labware. After the labware is engaged with the metal platform, the notched arm can engage and selectively move the metal platform (and in turn, the labware). However, in order for this approach to function, a metal platform must be installed at each location where labware is to be moved within a system, prior to initiation of the robotic workflow. Further, the liquid handling system must be modified to include a notched arm that is capable of engaging the metal platform(s).

As further disclosed herein, it is contemplated that the disclosed apparatuses, systems, and methods can facilitate the automated insertion of a labware item (e.g., an in-channel filter (ICF) device) into a receptacle (e.g., an electrophoresis cassette) within the footprint of a liquid handling system, including in circumstances where such an insertion process requires a substantial force (e.g. 10-50 lbs). The disclosed apparatus can be provided as a tool that is picked up by the pipetting head of a liquid handling robot (system) and subsequently used to pick up, transfer, position/insert, and release the labware item. Optionally, the labware item can be a single-use labware item.

The apparatus can function in a passive manner—that is, the apparatus does not require any power, and therefore the apparatus does not contain any actuated parts. Instead, the apparatus relies solely on the interaction between complementary engagement features on the apparatus and the labware item in order to create an appropriate pickup force. As further disclosed herein, it is contemplated that the complementary design features on the apparatus and the labware item can provide a differential holding force depending on the relative lateral or vertical position between the apparatus and the labware item. Thus, in some aspects, it is contemplated that lateral or vertical movement of the apparatus relative to the labware item can reduce or even eliminate the gripping force between the apparatus and the labware item, thereby permitting release of the labware item (e.g. after insertion into a receptacle).

Although other applications are contemplated, in some aspects, the disclosed apparatus and systems can be used during the performance of automated electrophoresis using a liquid handling system, such as for example the NIMBUS SELECT liquid handling system (Hamilton Company). As further described herein, it is contemplated that the disclosed apparatus, systems, and methods can avoid the need for relying upon an external robotic gripping solution (e.g. an industrial-style manufacturing arm), thereby avoiding the significant cost and complexity constraints associated with such a solution. In particular, in use, to facilitate the automated handling and insertion of labware items within the physical context of a liquid handling system, the passive apparatus disclosed herein can be engaged (“picked up”) by the pipetting head of the liquid handling system, and the pipetting head can then be used to achieve the pickup, transfer, and insertion of the labware item within the liquid handling system.

In contrast to the apparatus disclosed herein, conventional gripper mechanisms are unable to apply the force necessary to insert labware items (e.g., an ICF device) into a receptacle (e.g., cassette) within a liquid handling system. More particularly, even if an appropriate downward force (e.g. 10-50 lbs) could be applied by a z-axis actuator connected to such a conventional gripper mechanism—which often cannot occur—the gripper mechanism itself lacks sufficient robustness (mechanical strength) to transfer the downward force to the labware item (e.g., ICF device) without breaking.

### Apparatus for Engaging a Labware Item

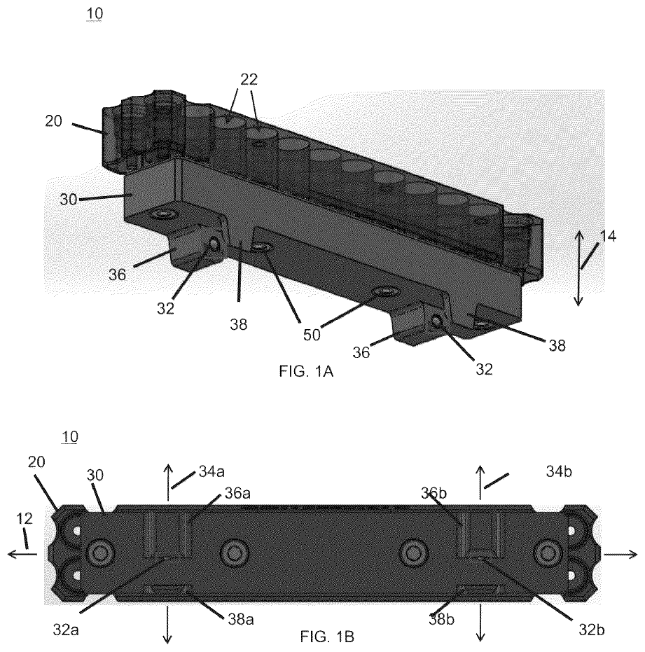

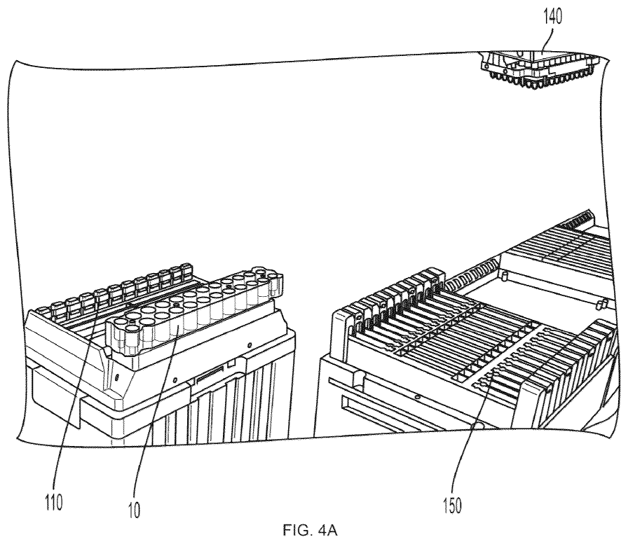

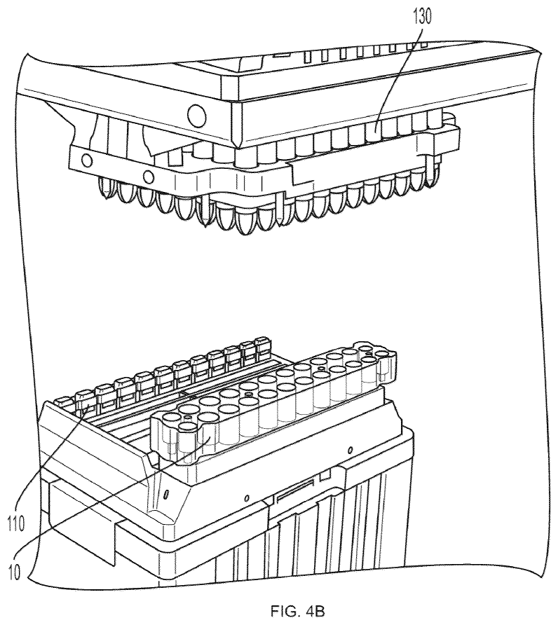

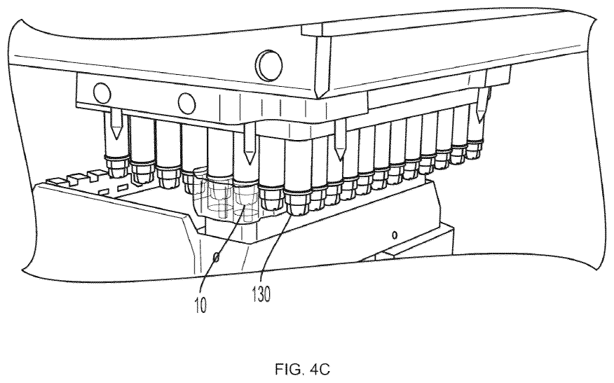

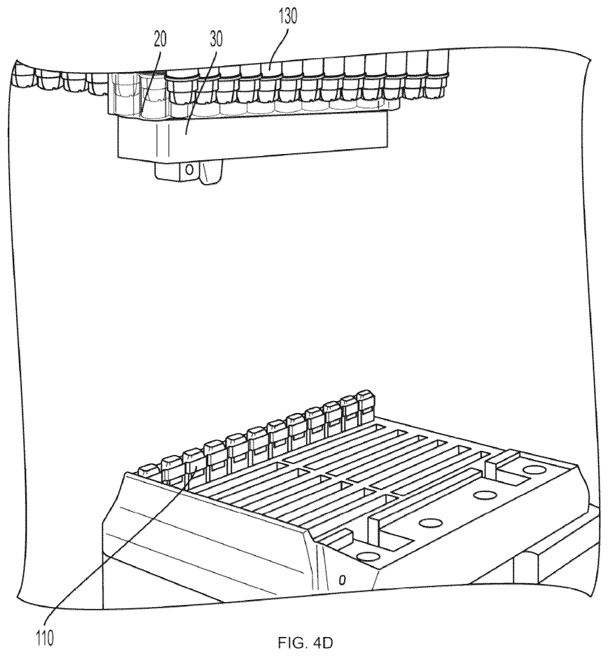

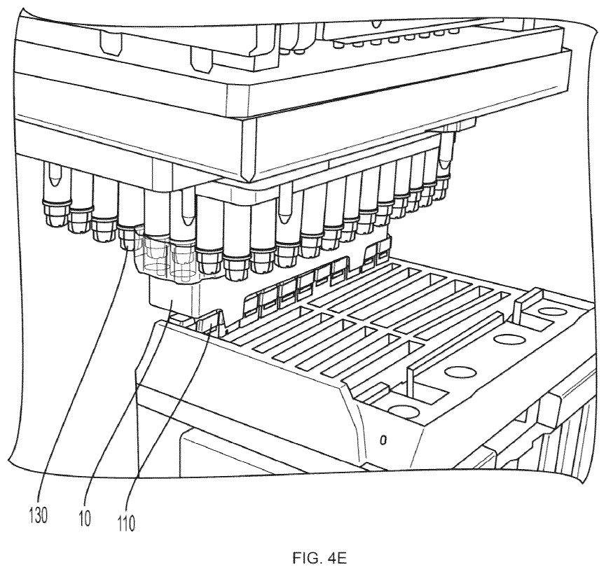

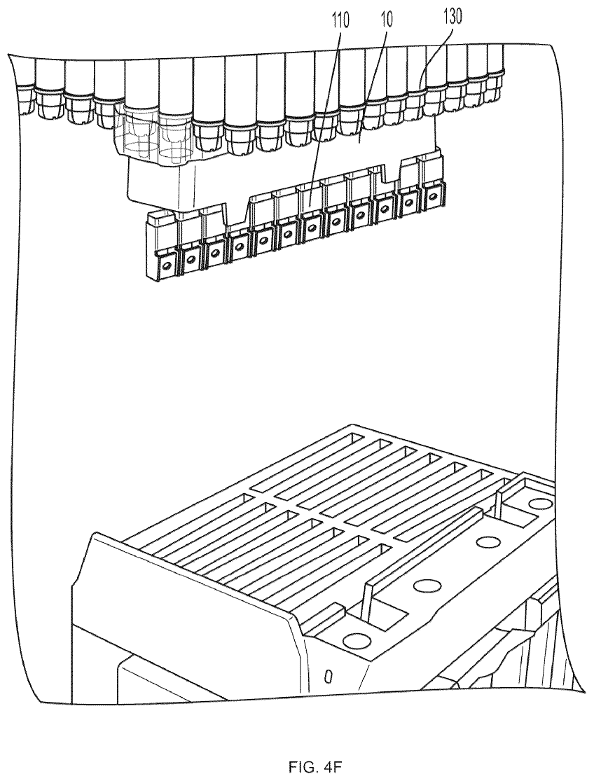

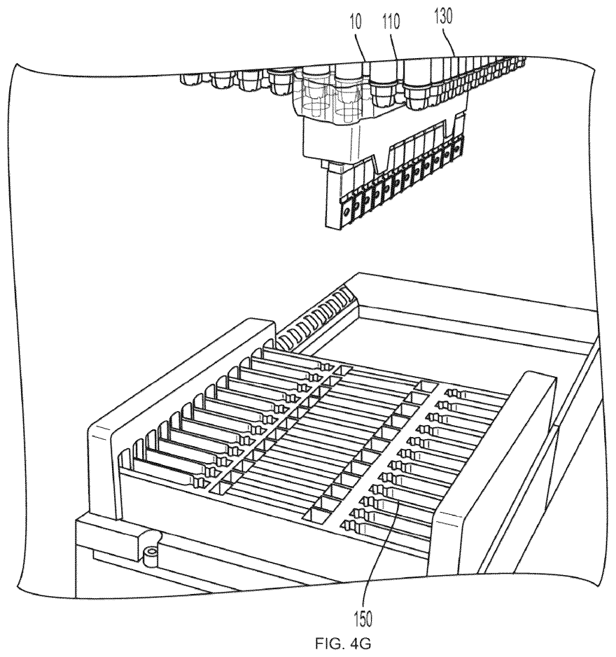

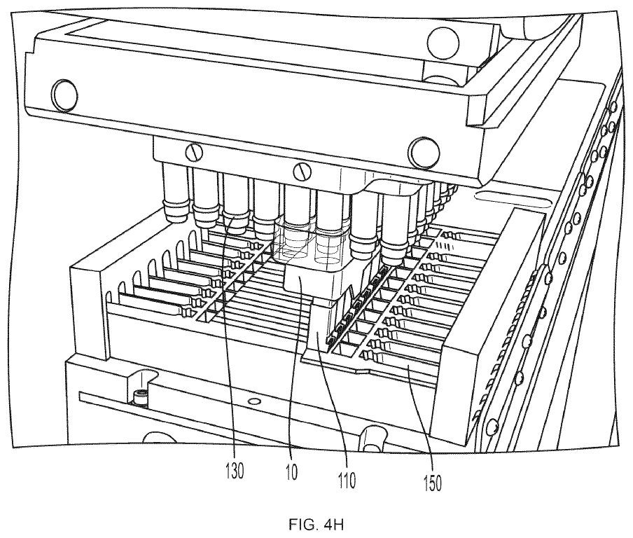

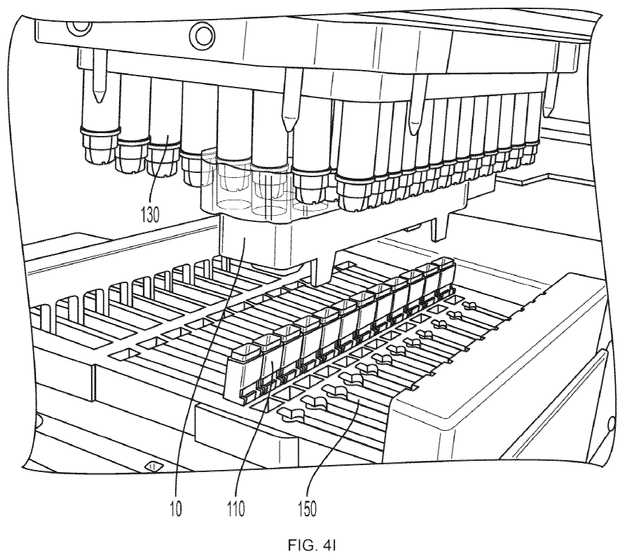

Referring to FIGS. 1A-1B, an apparatus 10 can comprise a body 20 that is configured for complementary engagement with a pipetting head 130 of a liquid handling system 140 (see FIGS. 4A-4I) such that movement of the pipetting head effects a corresponding movement of the apparatus. More particularly, it is contemplated that the body 20 can have a structure that is complementary to the distribution of pipette structures of the pipetting head 130. As used herein, the term “pipette structure” refers to a portion of a pipette that extends downwardly from a pipetting head, as well as any portion of the structure of the pipetting head that engages and/or secures a respective pipette in an operative position during use. Thus, as used herein, a “pipette structure” can include both a pipette as well as a mandrel that engages the pipette when used in its conventional manner. Optionally, in exemplary aspects, the pipetting head 130 can be used without pipettes secured to at least the portion of the pipetting head that is intended to engage the apparatus 10. A non-limiting example of a suitable pipetting head is the 96-channel CORE pipetting head (Hamilton Company). However, it is contemplated that the disclosed body 20 can have a structure that is complementary to the shape and dimensions of any pipetting platform. In exemplary aspects, the body 20 can define a plurality of openings 22 that are positioned to receive portions of the pipette structures (e.g., mandrels or shafts or spindles) that extend downwardly from the pipetting head 130. Optionally, in these aspects, the plurality of openings 22 can comprise a plurality of rows of multiple openings, with the openings of each row of the plurality of rows being spaced apart relative to a transverse axis 12 that is perpendicular to a vertical axis 14. In other aspects, it is contemplated that the plurality of openings 22 can be arranged within a single row. In exemplary aspects, it is contemplated that the number of openings 22 within a given row of openings can be the same as the number of pipette structures within a corresponding row of the pipetting head 130. In use, when the pipetting head 130 is in a selected overlying relation (alignment) to the body 20, a controller of the liquid handling system 140 can selectively lower the pipetting head 130 to engage the body 20 and securely couple the body to the pipetting head. Optionally, it is contemplated that the mandrels of the pipetting head 130 can be configured to directly engage inner surfaces within respective openings of the body 20, with no pipettes present.

In exemplary aspects, it is contemplated that the pipetting head 130 can engage the body 20 in various ways. For example, in some aspects, it is contemplated that each mandrel of the pipetting head 130 can have an o-ring at or proximate to the tip of the mandrel. In use, it is contemplated that the o-ring of each mandrel can be configured to expand radially outwardly after the mandrel has engaged the body 20. For example, the o-ring of each mandrel can create a high-friction engagement force with the surfaces of the body 20 that define openings within which the mandrel is received. Additionally, or alternatively, in further aspects, it is contemplated that each mandrel can have a tapered profile that is complementary to an opening of the body 20 within which the mandrel is received, thereby creating frictional engagement between the outer surfaces of the mandrel and the inner surfaces of the opening. Exemplary pipetting heads 130 that can function as described above include the CO-RE pipette interface (Hamilton Company), which can optionally be used in combination with a NIMBUS Select liquid handling system (Hamilton Company). Following engagement of an apparatus by a pipetting head 130 as disclosed herein, it is contemplated that a built-in tip-removal mechanism of the pipetting head can be selectively activated to disengage the apparatus, for example, after the labware item is positioned in the selected location. In exemplary aspects, the pipetting head 130 can comprise a sleeve that is positioned outwardly of the mandrel and configured to translate (e.g., downwardly or laterally) to “eject” or otherwise disengage the apparatus. When the CO-RE pipette interface is used, it is contemplated that the same mechanism that expands the o-rings can simply be disengaged, thereby eliminating the force holding the apparatus in place. The CO-RE pipetting head further comprises a sleeve ejector apparatus to help ensure complete disengagement of the apparatus.

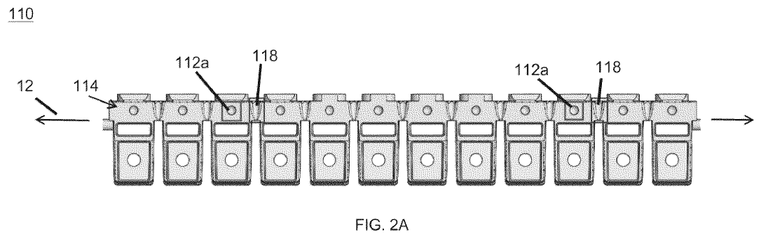

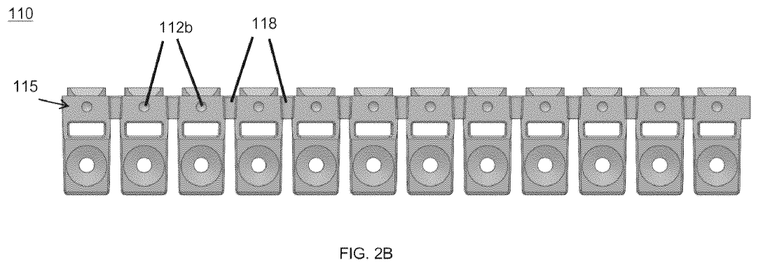

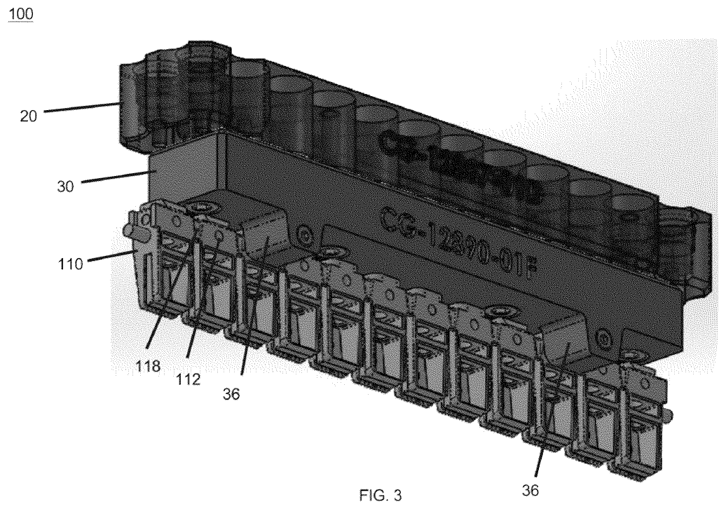

In further exemplary aspects, the apparatus 10 can comprise a base 30 that is coupled to the body 20. In these aspects, the base 30 can comprise at least one engagement feature 32 that is configured to mechanically (e.g. frictionally, or via direct interference contact between complementary surfaces) engage a surface of a labware item 110 (see FIGS. 2-3) to releasably couple the labware item to the apparatus 10. In various aspects, it is contemplated that the base 30 can extend outwardly (for example, downwardly or laterally) from the body 20.

In exemplary aspects, the at least one engagement feature 32 can comprise a plurality of engagement features. In these aspects, it is contemplated that the plurality of engagement features 32 can be spaced along the transverse axis 12. As further disclosed herein, the plurality of engagement features can be oriented in alignment with respective engagement axes that are perpendicular to the transverse axis 12 and the vertical axis 14. For example, the plurality of engagement features can comprise first and second engagement features that are respectively aligned with first and second engagement axes 34a, 34b. Although examples disclosed herein describe two engagement features, it is contemplated that any desired number of engagement features can be provided.

In various exemplary aspects, the plurality of engagement features can comprise a plurality of “male” components (e.g., projections, posts, and the like) that are received within corresponding “female” receptacles (keyholes, recesses, openings, slots, indentations, and the like) of a labware item as further disclosed herein. For example, the plurality of engagement features can comprise first and second plungers 32a, 32b that are respectively biased to extend outwardly (from the base 30) relative to the first and second engagement axes 34a, 34b. Optionally, in these aspects, the first and second plungers 32a, 32b can be respectively spring-loaded to extend outwardly (in the direction toward the labware item 110 to be engaged) relative to the first and second engagement axes 34a, 34b. As shown in FIGS. 1A-1B, the first and second plungers 32a, 32b can be biased to extend toward a respective projection 38a, 38b as further described below. Although the engagement features 32 of the apparatus 10 are depicted as plungers, it is contemplated that other complementary engagement structures can be used. Examples of other suitable engagement features include machined features (nub, projection, key, tongue, and the like), spring tabs, compressible surfaces, textured or treated surfaces, or combinations thereof. In further aspects, compression or deflection of the engagement feature 32, the supporting leg 36, the labware 110, a complementary engagement feature on the labware 112, or some combinations thereof, can be used to produce a mechanical (e.g., friction-based) engagement force. In still other exemplary aspects, the engagement features 32 of the apparatus 10 can comprise articulated or jointed structures that mechanically engage portions of the labware item as the apparatus is brought into contact with the labware item. It is contemplated that such structures can comprise one or more latch elements that move about and between an engaged or deployed position and a released or retracted position, for example, in response to a force (e.g., a downward, upward, or lateral force) experienced while picking up and placing/inserting the labware item as further disclosed herein.

In other exemplary aspects, the plurality of engagement features 32 can comprise one or more “female” receptacles (e.g., slots, openings, recesses, indentations, keyholes, other “female” receiving spaces, and the like) that are configured to engage and at least partially receive a “male” component (e.g., a projection, a post, a plunger, and the like) associated with a labware item to thereby couple the base 30 to the labware item.

In further aspects, the base 30 can comprise at least one leg 36. In various aspects, each leg of the at least one leg 36 can define or receive (house) a portion of a respective engagement feature 32. In these aspects, it is contemplated that each leg 36 can extend outwardly from an outer surface of the base 30. Optionally, each leg 36 can extend downwardly from a bottom surface of the base 30. However, in other aspects, each leg 36 can extend laterally or upwardly from an outer surface of the base 30.

Optionally, in some exemplary aspects, each leg 36 can define a bore or cavity that is in alignment with a respective engagement axis and shaped to receive (house) a portion of a respective engagement feature. For example, in these aspects, the at least one leg 36 can comprise first and second legs 36a, 36b that receive (house) respective portions of first and second engagement features (e.g., the first and second plungers 32a, 32b). However, it is contemplated that any desired number of legs 36 (and associated engagement features) can be used.

Optionally, in other exemplary aspects, each leg 36 can define a respective “female” engagement feature (e.g., a recess or keyhole) as disclosed herein. For example, the at least one leg 36 can comprise first and second legs 36a, 36b that define respective “female” engagement features. However, it is contemplated that any desired number of legs 36 (and associated engagement features) can be used.

In still further aspects, the base 30 can further comprise at least one projection 38 that extends outwardly from an outer surface of the base. Optionally, in these aspects, the at least one projection 38 can extend downwardly from a bottom surface of the base. However, in other aspects, the at least one projection 38 can extend laterally or upwardly from an outer surface of the base. Optionally, in various aspects, each projection 38 can be in alignment with a respective engagement axis. Alternatively, at least one projection 38 (optionally, each projection) can be offset from the engagement axes (that are aligned with the engagement features 32) such that no engagement axis intersects the projection 38. In exemplary aspects, the at least one projection 38 can comprise first and second projections 38a, 38b. As shown, in these aspects, the first projection 38a can be spaced from and aligned with the first leg 36a relative to the first engagement axis 34a, and the second projection 38b can be spaced from and aligned with the second leg 36b relative to the second engagement axis 34b. In use, each projection 38 can be configured to engage a surface of a labware item 110 that is opposed to the surface of the labware item that faces or is to be engaged by a corresponding engagement feature 32, thereby providing additional support to the labware item.

Optionally, the body 20 and the base 30 can be integrally formed as a monolithic structure. In some exemplary aspects, at least one of the body 20 or the base 30 (optionally, both the body 20 and the base 30, either together or separately) can be formed using conventional machining, injection molding, or three-dimensional printing techniques. In other optional aspects, and as shown in FIGS. 1A-1B, the base can be secured to the body by at least one fastener 50. Optionally, in these aspects, the at least one fastener 50 can comprise a plurality of screws or bolts that extend vertically or laterally through at least a portion of the body 20 and at least a portion of the base 30. As shown, it is contemplated that such fasteners 50 can be positioned so that they are spaced from the openings 22 of the body 20 as well as the engagement features 32 of the base 30, thereby preventing interference with operation of the apparatus 10 as further disclosed herein.

In exemplary aspects, it is contemplated that the body 20 and/or the base 30 of the apparatus 10 can comprise non-brittle, high-strength plastics, including, for example and without limitation, polycarbonate, ABS, Delrin, PEEK, and the like, thereby ensuring that the apparatus 10 is lightweight and robust. Alternatively, in other aspects, it is contemplated that the body 20 and/or the base 30 can comprise a metallic material, such as for example and without limitation, aluminum.

As further described herein, it is contemplated that the apparatus 10 does not comprise a power source. It is further contemplated that the apparatus 10 does not comprise an actuator. Instead, all movement of the apparatus 10 is driven by the actuators (e.g., high-power actuators) of the pipetting head 130 of the liquid handling system 140, which are mechanically coupled to the apparatus. Thus, it is contemplated that the disclosed apparatus 10 can be used without the need for modifying the electrical and/or power setup of the liquid handling system 140.

### Systems for Engaging and Positioning a Labware Item

As shown in FIGS. 2-3, the disclosed apparatus 10 can be provided as a component of a system 100, which can also include a labware item 110 having at least one engagement feature 112 that is complementary to and configured to releasably engage a corresponding engagement feature 32 of the at least one engagement feature of the apparatus. Optionally, in exemplary aspects, the at least one engagement feature 112 of the labware item 110 can comprise a plurality of engagement features spaced relative to the transverse axis 12. In exemplary aspects, the at least one engagement feature 112 of the labware item 110 can comprise at least a portion of a feature or surface 114 that is shaped or otherwise configured to provide sufficient gripping force when engaged with the at least one engagement feature 32 of the apparatus 10.

In exemplary aspects, and with reference to FIG. 3, the labware item 110 can have a width (for example, a width relative to each respective engagement axis). In these aspects, the width of the labware item can be less than a spacing between the projection 38 and the leg 36 of the apparatus 10, thereby permitting receipt of the labware item between the projection and the leg of the apparatus.

Optionally, in exemplary aspects, the labware item 110 can be an In-Channel Filter (ICF) device. In further optional aspects, it is contemplated that the labware item 110 can be an electrode device designed to engage an electrophoresis cassette. Exemplary ICF devices and electrode devices, which can be modified to have engagement and release features as disclosed herein, are sold and/or manufactured by COASTAL GENOMICS. In still further optional aspects, the labware item 110 can be a microtitre plate designed to engage a passive receptacle (e.g. a passive positional location within a liquid handling system) or a functionally active receptacle (e.g. a vacuum manifold). It is contemplated that these disclosed examples of labware items 110 can correspond to conventional or standard versions of these labware items 110 that have been modified to include engagement features 112 and/or release features 118 as disclosed herein. Thus, it is contemplated that the disclosed labware items 110 can optionally be modified after the initial manufacture of the labware items. Alternatively, it is contemplated that the process for the initial manufacture of the labware items can be modified to incorporate the structural modifications disclosed herein. In some cases, depending on the apparatus engagement feature 32 being employed, it is contemplated that an existing surface of a labware item (e.g., surface 114) can serve as an adequate complementary engagement feature 112 without further modification.

In further aspects, it is contemplated that the system 100 can further comprise the pipetting head 130. In these aspects, it is further contemplated that the system can further comprise the liquid handling system 140 (e.g., a liquid handling robot) that includes the pipetting head 130.

Systems Having Labware Items with “Female” Engagement Features

In further exemplary aspects, and as shown in FIG. 2, the at least one engagement feature 112 of the labware item 110 can comprise at least one “female” receptacle (e.g., a recess, keyhole, and the like) defined in the surface 114 of the labware item. In these aspects, when the at least one engagement feature 32 of the apparatus 10 comprises at least one plunger, it is contemplated that a head of each plunger can have a shape that is complementary to a shape of a corresponding receptacle (e.g., recess) of the at least one receptacle (e.g., recess) of the labware item 110. Optionally, in exemplary aspects, the head of each plunger can have a ball shape as is known in the art. In these aspects, it is contemplated that each receptacle (e.g., recess) of the labware item 110 can have a dimple-like shape that is complementary to the ball shape of the plunger. However, it is contemplated that the receptacle can be provided in other forms, including, for example, a slot, a groove, an opening, or similar structure for receiving a complementary structure of a respective engagement feature 32 of the base 30.

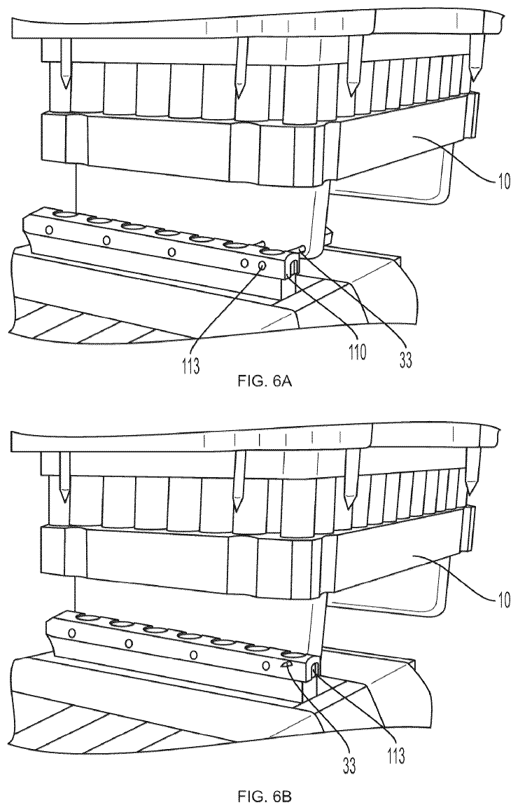

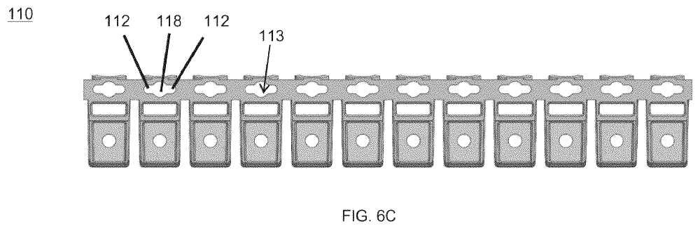

FIGS. 6A-6C depict an exemplary embodiment in which each engagement feature 32 of the apparatus is provided as a post 33 (or projection) and each receptacle of the labware item is provided in the form of a slot 113. As shown, in this embodiment, each slot can have a variable profile (e.g., a variable height or depth) that changes moving along an axis (e.g., the transverse axis or the vertical axis), thereby providing a variable force of engagement as the apparatus translates relative to the labware item as further disclosed herein. For example, as shown in FIG. 6C, each slot 113 can have an intermediate section that forms an enlarged opening in comparison to adjoining end sections positioned on either side of the intermediate section. In these aspects, it is contemplated that the engagement feature 32 (e.g., post 33) can be received (optionally, initially received) within one of the end sections (with the limited opening), thereby providing a first engagement force. It is further contemplated that the engagement feature 32 can be translated (laterally or vertically (downwardly or upwardly)) until it is received within the intermediate section, thereby providing a second engagement force that is less than the first engagement force and permitting the engagement feature to be retracted from the slot 113 to disengage the labware item 110. Thus, it is contemplated that the end sections of the slot 113 can define the engagement features 112, while the intermediate section of the slot 113 can define the release features 118 as further disclosed herein. Optionally, rather than being initially received in an end section, it is contemplated that the engagement feature 32 can be initially received in the intermediate section before being translated (laterally or vertically) until it is received in one of the end sections to produce the previously referenced first engagement force. This approach can be advantageous in cases where receipt of the engagement feature of the apparatus 32 (e.g., post 33) within the engagement feature of the labware item 112 is best accomplished through relative movement along the transverse axis 12. Optionally, each slot 113 can extend through the thickness or depth of the labware item or a wall of the labware item such that a post 33 can extend beyond the slot. Optionally, the apparatus 10 can comprise one or more legs which define or are coupled to the posts 33 (or projections).

In still further aspects, it is contemplated that the engagement feature 112 can comprise a textured or treated surface that is configured to provide sufficient mechanical (e.g., frictional) engagement with a corresponding engagement feature 32 of the base 30 to engage the labware item 110 in the manner disclosed herein.

Optionally, in still further aspects, the labware item 110 can have at least one release feature 118 that is configured to releasably engage or at least partially receive a corresponding engagement feature 32 of the at least one engagement feature of the apparatus in response to translation (e.g., lateral translation along the transverse axis 12) of the apparatus 10 relative to the labware item. As used in this context, the term “releasably engage” is meant to refer to contact between the engagement feature 32 and the release feature 118 that can be selectively discontinued upon further translation of the apparatus relative to the labware item. In use, with the labware item 110 engaged by the apparatus 10, it is contemplated that the liquid handling system 140 can be configured to move the pipetting head 130 so that the labware item is received within a receptacle 150 (e.g., within a corresponding cavity or cavities of a receptacle), such as, for example, and without limitation, a cassette for use in a liquid handling process. Optionally, the cassette can be configured to have a cavity that is configured to complementarily receive an ICF device as further disclosed herein. More generally, it is contemplated that the cassette can be selected to have at least one cavity that is configured to complementarily receive at least a portion of the labware item 110 that is engaged by the apparatus 10. With the labware item 110 received within the receptacle 150, the structure of the receptacle can restrict or prevent movement of the labware item in one or more directions. For example, the receptacle can restrict or prevent lateral movement of the labware item. Thus, when the liquid handling system 140 initiates movement of the pipetting head 130 in the one or more directions (e.g., in a lateral or vertical direction), the apparatus 10 translates (e.g., translates laterally or vertically) relative to the labware item 110 until at least one (optionally, each) engagement feature 32 of the apparatus 10 is received within or releasably engages a respective release feature 118. In some aspects, it is contemplated that the engagement features 32 can be received within corresponding release features 118 without contacting the labware item. In other aspects, it is contemplated that the engagement features 32 can be in releasable engagement with corresponding release features such that further translation of the apparatus decreases the mechanical engagement until the engagement features 32 are no longer in contact with release features (or any other portion of the labware item).

As shown in FIGS. 2-3, in exemplary aspects, the at least one release feature 118 of the labware item 110 can comprise at least one groove defined within the surface 114 of the labware item. In these aspects, each groove of the at least one groove can be laterally spaced from a respective engagement feature 112 of the at least one engagement feature of the labware item. Optionally, as shown, a plurality of grooves can be provided, with at least some of the grooves positioned laterally between sequential engagement features of the labware item. In further aspects, each groove of the at least one groove can have a variable width (measured relative to the transverse axis 12) and/or a variable depth that increases moving in an upward direction. Such a tapered geometry can ensure that a force of engagement between the at least one groove and the at least one engagement feature 32 of the apparatus 10 decreases as the apparatus is translated in a direction (e.g., an upward direction) relative to the labware item 110; consequently, this tapered geometry can encourage the release of the labware item from the apparatus as the apparatus moves in the direction (e.g., upwards). In these aspects, it is further contemplated that the gripping force that exists between the apparatus 10 and the labware item 110 is lower during the disengagement movement than the gripping force that exists during engagement or transport of the labware.

Although described above as having a variable depth and/or a variable width, it is contemplated that each release feature 118 of the labware item 110 can have any structure and/or material properties that are configured to provide a release force that is less than the force required to establish the initial engagement between the apparatus 10 and the labware item. Preferably, but not required, it is contemplated that each release feature 118 can provide a variable force of engagement (i.e., frictional engagement force) that decreases moving in a direction (e.g., an upward direction) so that movement of the apparatus in the direction (e.g., in an upward direction) will easily disengage the labware item 110 from the apparatus. Other non-limiting examples of release features 118 include: sections of the labware item 110 having a lower coefficient of friction than the engagement features 112; sections of the labware item 110 that are differentially compressible, relative to the engagement features 112; grooves or channels which fully exclude or avoid contact with the engagement feature 32 of the apparatus 10; beveled, tapered, or curved surfaces that progressively decrease the amount of contact with an engagement feature 32 of the apparatus 10; or combinations thereof.

Optionally, in some aspects, and with reference to FIGS. 2A-2B, it is contemplated that the labware item 110 can have opposing first and second outer surfaces, and the at least one engagement feature 112 of the labware item can comprise at least one first engagement feature 112a positioned along the first outer surface 114 and at least one second engagement feature 112b positioned along the second outer surface 115. In these aspects, it is contemplated that each first engagement feature of the at least one first engagement feature can be in alignment with a corresponding second engagement feature of the at least one second engagement feature relative to a respective engagement axis. Optionally, it is further contemplated that the at least one first engagement feature can comprise a plurality of first engagement features, and the at least one second engagement features can comprise a plurality of second engagement features. In exemplary aspects, the first outer surface can have at least one release feature 118 (optionally, a plurality of release features). Similarly, it is contemplated that the second outer surface can have at least one release feature 118 (optionally, a plurality of release features) in the same manner of the first surface. In further aspects, each engagement feature of the at least one engagement feature of the apparatus is configured to engage either a first engagement feature or a second engagement feature of the labware item. Thus, in use, it is contemplated that the presence of engagement features 112 and release features 118 on both sides of the labware item 110 can allow the apparatus 10 to engage the labware item 110 regardless of the initial orientation of the labware item. In further aspects, it is contemplated that when at least one projection 38 is provided on the apparatus 10, the projection can define an engagement surface that is configured to engage a respective second engagement feature of the labware item.

Although depicted in the Figures as having release features 118, it is contemplated that the labware item 110 can be provided without distinct release features in certain embodiments. For example, when the engagement features of the apparatus comprise latch elements or other structures that can be selectively deployed or retracted to adjust the force of engagement between the apparatus and the labware item, it is contemplated that the release features can be omitted without affecting the functionality of the disclosed system.

Systems Having Labware Items with “Male” Engagement Features

In further exemplary aspects, the at least one engagement feature 112 of the labware item 110 can comprise at least one “male” feature (e.g., a projection, a post, a plunger, and the like) that extends outwardly from the surface 114 of the labware item. In these aspects, when the at least one engagement feature 32 of the apparatus 10 comprises at least “female” receptacle, it is contemplated that each “male” feature 112 of the labware item can have a shape (e.g., a ball shape) that is complementary to a shape (e.g., a dimple-like shape) of a corresponding receptacle (e.g., recess, a slot, a groove, an opening, and the like) of the at least one receptacle (e.g., recess) of the labware item 110. For example, it is contemplated that each receptacle of the apparatus 10 can have a dimple-like shape that is complementary to a ball shape of a corresponding “male” feature of the labware item 110.

In exemplary aspects, the “male” engagement features of the labware item can be provided as a post (or projection), and each “female” receptacle of the apparatus 10 can be provides as a slot. In these aspects, it is contemplated that each slot can have a variable profile (e.g., a variable height, diameter, or depth) that changes moving along an axis (e.g., the transverse axis or the vertical axis), thereby providing a variable force of engagement as the apparatus translates relative to the labware item as further disclosed herein. For example, each slot can have an intermediate section that forms an enlarged opening in comparison to adjoining end sections positioned on either side of the intermediate section. In these aspects, it is contemplated that the “male” engagement feature (e.g., post) of the labware item can be received (optionally, initially received) within one of the end sections (with the limited opening), thereby providing a first engagement force. It is further contemplated that the apparatus can be translated (laterally or vertically) relative to the labware item such that each “male” engagement feature of the labware item is received within the intermediate section, thereby providing a second engagement force that is less than the first engagement force and permits the apparatus to be easily translated such that the “female” engagement feature(s) disengage the “male” engagement feature(s) of the labware item. Thus, it is contemplated that the end sections of the slot can define the engagement features 32, while the intermediate section of the slot can define release features of the apparatus. Optionally, rather than being initially received in an end section, it is contemplated that the engagement feature 112 of the labware item can be initially received in the intermediate section before the apparatus 10 is translated (laterally or vertically) such that the engagement feature 112 is received in one of the end sections to produce the previously referenced first engagement force. This approach can be advantageous in cases where receipt of the engagement feature 112 of the labware item 110 within the engagement feature of the apparatus 32 is best accomplished through relative movement along the transverse axis 12. Optionally, each slot of the apparatus 10 can extend through a leg 36 of the base 30 such that a “male” engagement feature of the labware item can extend beyond the slot.

In still further aspects, it is contemplated that the engagement feature 32 can comprise a textured or treated surface that is configured to provide sufficient mechanical (e.g., frictional) engagement with a corresponding engagement feature 112 of the labware item 100 to engage the labware item 110 in the manner disclosed herein.

Optionally, in still further aspects, the apparatus 10 can have at least one release feature that is configured to releasably engage or at least partially receive a corresponding engagement feature 112 of the at least one engagement feature of the labware item 110 in response to translation (e.g., lateral translation along the transverse axis 12) of the apparatus 10 relative to the labware item. As used in this context, the term “releasably engage” is meant to refer to contact between the engagement feature 112 of the labware item and the release feature of the apparatus 10 that can be selectively discontinued upon further translation of the apparatus relative to the labware item. In use, with the labware item 110 engaged by the apparatus 10, it is contemplated that the liquid handling system 140 can be configured to move the pipetting head 130 so that the labware item is received within a receptacle 150 (e.g., within a corresponding cavity or cavities of a receptacle), such as, for example, and without limitation, a cassette for use in a liquid handling process. Optionally, the cassette can be configured to have a cavity that is configured to complementarily receive an ICF device as further disclosed herein. More generally, it is contemplated that the cassette can be selected to have at least one cavity that is configured to complementarily receive at least a portion of the labware item 110 that is engaged by the apparatus 10. With the labware item 110 received within the receptacle 150, the structure of the receptacle can restrict or prevent movement of the labware item in one or more directions. For example, the receptacle can restrict or prevent lateral movement of the labware item. Thus, when the liquid handling system 140 initiates movement of the pipetting head 130 in the one or more directions (e.g., in a lateral or vertical direction), the apparatus 10 translates (e.g., translates laterally or vertically) relative to the labware item 110 until at least one (optionally, each) engagement feature 112 of the labware item 110 is received within or releasably engages a respective release feature of the apparatus. In some aspects, it is contemplated that the engagement features 112 can be received within corresponding release features without contacting the apparatus. In other aspects, it is contemplated that the engagement features 112 can be in releasable engagement with corresponding release features such that further translation of the apparatus decreases the mechanical engagement until the engagement features 112 are no longer in contact with release features (or any other portion of the apparatus).

In exemplary aspects, the at least one release feature of the apparatus 10 can comprise at least one groove defined within a surface of the apparatus (for example, a surface of the base 30). In these aspects, each groove of the at least one groove can be laterally spaced from a respective engagement feature 32 of the at least one engagement feature of the apparatus 10. Optionally, a plurality of grooves can be provided, with at least some of the grooves positioned laterally between sequential engagement features of the apparatus 10. In further aspects, each groove of the at least one groove can have a variable width (for example, measured relative to the transverse axis 12) and/or a variable depth (for example, that increases moving in an upward direction). Such a tapered geometry can ensure that a force of engagement between the at least one groove and the at least one engagement feature 112 of the labware item 110 decreases as the apparatus is translated in a direction (e.g., an upward direction) relative to the labware item 110; consequently, this tapered geometry can encourage the release of the labware item from the apparatus as the apparatus moves in the direction (e.g., upwards). In these aspects, it is further contemplated that the gripping force that exists between the apparatus 10 and the labware item 110 is lower during the disengagement movement than the gripping force that exists during engagement or transport of the labware item.

Although described above as having a variable depth and/or a variable width, it is contemplated that each release feature of the apparatus 10 can have any structure and/or material properties that are configured to provide a release force that is less than the force required to establish the initial engagement between the apparatus 10 and the labware item 110. Preferably, but not required, it is contemplated that each release feature can provide a variable force of engagement (i.e., frictional engagement force) that decreases moving in a direction (e.g., an upward direction) so that movement of the apparatus in the direction (e.g., in an upward direction) will easily disengage the labware item 110 from the apparatus. Other non-limiting examples of release features include: sections of the apparatus 10 having a lower coefficient of friction than the engagement features 32; sections of the apparatus 10 that are differentially compressible, relative to the engagement features 32; grooves or channels which fully exclude or avoid contact with the engagement feature 112 of the labware item 110; beveled, tapered, or curved surfaces that progressively decrease the amount of contact with an engagement feature 112 of the labware item 110; or combinations thereof.

Optionally, in some aspects, it is contemplated that the base 30 of the apparatus 10 can have opposing first and second outer surfaces, and the at least one engagement feature 32 of the apparatus 10 can comprise at least one first engagement feature positioned along the first outer surface and at least one second engagement feature positioned along the second outer surface. In these aspects, it is contemplated that each first engagement feature of the at least one first engagement feature can be in alignment with a corresponding second engagement feature of the at least one second engagement feature relative to a respective engagement axis. Optionally, it is further contemplated that the at least one first engagement feature can comprise a plurality of first engagement features, and the at least one second engagement features can comprise a plurality of second engagement features. In exemplary aspects, the first outer surface can have at least one release feature (optionally, a plurality of release features). Similarly, it is contemplated that the second outer surface can have at least one release feature (optionally, a plurality of release features) in the same manner of the first surface. In further aspects, each engagement feature of the at least one engagement feature of the apparatus is configured to engage either a first engagement feature or a second engagement feature of the labware item. Thus, in use, it is contemplated that the presence of engagement features 32 and release features on both sides of the apparatus 10 can allow the apparatus 10 to engage the labware item 110 regardless of the initial orientation of the labware item.

### Methods of Engaging and Positioning a Labware Item

Consistent with the apparatus and systems disclosed herein, and with reference to FIGS. 4A-4I, a method can comprise using the pipetting head of the liquid handling system to engage the apparatus. The method can further comprise using the pipetting head to position the apparatus relative to (optionally, above) a labware item having at least one engagement feature that is complementary to a corresponding engagement feature of the at least one engagement feature of the apparatus. The method can further comprise using the pipetting head to position the apparatus relative to (optionally, lower the apparatus over) the labware item such that at least one engagement feature of the apparatus releasably engages a corresponding engagement feature of the at least one engagement feature of the labware item. With the apparatus releasably engaging the labware item, the method can further comprise using the pipetting head to selectively move the apparatus and the labware item (together). As further described herein, the pipetting head can translate along an axis (for example, downwardly or at least partially downwardly along a vertical axis) to engage the apparatus, and the at least one engagement feature of the labware item can comprise a plurality of engagement features that are spaced relative to the transverse axis. As used herein, the term “partially downwardly” refers to movement that results in the pipetting head (or other structure) being positioned at a lower position relative to a vertical axis, even if such movement also results in a change in position relative to one or more horizontal axes.

In further aspects, the method can comprise using the pipetting head to position the labware item within a receptacle that restricts movement of the labware item. In these aspects, the method can further comprise using the pipetting head to translate (e.g., laterally translate or vertically translate) the apparatus relative to the labware item. As further disclosed herein, the labware item can have at least one release feature that releasably engages a corresponding engagement feature of the at least one engagement feature of the apparatus in response to translation (e.g., lateral translation or vertical translation) of the apparatus relative to the labware item.

In still further aspects, the method can comprise using the pipetting head to translate the apparatus in at least one direction (for example, an upward or at least partially upward direction, or in a lateral or at least partially lateral direction) relative to the labware item until the apparatus disengages the labware item. As used herein, the term “partially upward” refers to movement that results in the apparatus being positioned at a higher position relative to a vertical axis, even if such movement also results in a change in position relative to one or more horizontal axes. Similarly, the term “partially lateral” refers to movement that results in the apparatus being positioned at a different position relative to a horizontal axis (e.g., the transverse axis), even if such movement also results in a change in position relative to the vertical axis. In these aspects, it is contemplated that a force of engagement between the at least one release feature 118 and the at least one engagement feature of the apparatus 32 is less than the force of engagement between the at least one engagement feature of the labware item 112 and the at least one engagement feature of the apparatus 32. Optionally, in these aspects, it is further contemplated that the force of engagement between the at least one release feature 118 and the at least one engagement feature of the apparatus 32 decreases as the apparatus is translated in the direction (e.g., upward or at least partially upward direction or lateral or at least partially lateral direction) relative to the labware item. Optionally, as disclosed herein, each release feature can be a groove having a variable width and/or variable depth.

Optionally, in still further aspects, the method can further comprise using the pipetting head to translate the apparatus to apply a force (e.g., a downward force) to the labware item to ensure that the labware item is fully received within the receptacle. Thus, after the labware item is disengaged (and at least partially received within the receptacle), the pipetting head can be controlled to translate relative to (e.g., above) the labware item and apply a force (e.g., a downward force) at one or more locations along the length of the labware item to ensure that the labware item is fully received within the receptacle.

In operation, it is contemplated that the disclosed apparatus, systems, and methods can provide various advantages in comparison to existing gripper mechanisms. For example, it is contemplated that the disclosed apparatus, systems, and methods can leverage the high-force actuators of the liquid handling system to drive the pipetting head, thereby providing for higher levels of force for initiation of the gripping action, transporting the labware item, and ensuring that the labware item is fully received within the receptacle. As used herein, the term “fully received” indicates that the portion of the labware item that is designed to be complementarily received within the receptacle is fully received or nested within the receptacle. As another example, the disclosed apparatus, systems, and methods can employ a top-down engagement approach that allows for transfer of the full force of the high-force actuators to the labware item during initial engagement. It is contemplated that this top-down engagement approach can also allow for a low-profile design of the apparatus, thereby minimizing the possibility of physical interference with other objects that may be in close lateral proximity to the labware item during pickup and release of the labware item.

In further exemplary aspects, it is contemplated that the dimensions of the apparatus (in particular, the structure and dimensions of the base 30) can be specific to the labware item that is being engaged. Because the disclosed apparatus is a passive device, it is contemplated that the apparatus can be inexpensive to manufacture, thereby making labware-specific customization of the apparatus financially feasible (particularly when compared to, for example, building a custom-sized gripper for engaging a non-standard piece of labware).

As further described herein, the friction-based or interference-based pick-up mechanism disclosed herein can allow the friction or interference force to be modulated based on the lateral position of the apparatus relative to the labware item. In use, this feature allows the apparatus to be positioned to ensure a high mechanical engagement (e.g., high friction) force when picking up and transporting the labware item, and then laterally repositioned (i.e. with a small sideways/lateral movement) after placing/inserting the labware item within a receptacle to permit a low-force release. This effectively replicates the “pickup” and “release” functionality of an actuated gripper in a passive device (i.e. that does not include actuators or a power source). As further described herein, the latching-based pick-up mechanism disclosed herein also effectively replicates the “pickup” and “release” functionality of an actuated gripper in a passive device (i.e. that does not include actuators or a power source). As disclosed herein, this functionality relies on complementary features on the pick-up apparatus and the labware item itself. In some embodiments, such as when the engagement feature of the apparatus is compressible or friction-based, or when the engagement feature comprises a latching mechanism, the complementary feature on the labware can be an appropriately positioned and oriented portion of an outer surface of the labware item.

As further described herein, the apparatus can provide a differential mechanical engagement (e.g., friction) force for the “pick up” and “release” operations. As described above, this can be facilitated by 1) the complementary features on the apparatus and the labware item, and 2) a relative movement (e.g., a relative lateral movement) between the apparatus and the labware item. Importantly, the ability to perform this movement (e.g., lateral movement) relies on the labware item being adequately supported, thereby allowing the apparatus to move in a direction (e.g., a lateral direction) while the labware item remains stationary. Alternatively, this functionality can be accomplished by the engagement feature 32 toggling between two latching states (engage vs. release), for example in response to a force (e.g., a downward force) that is exerted during the pickup and the placement of the labware item.

### Computing Device

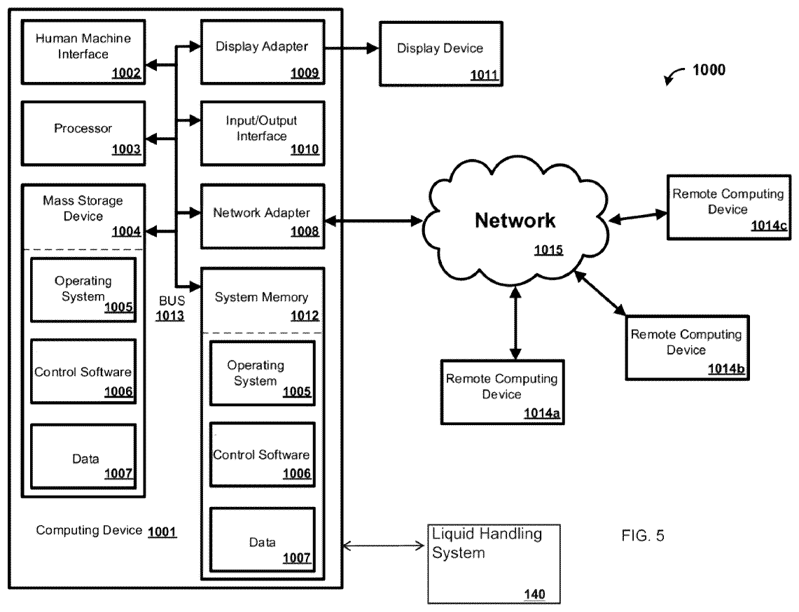

FIG. 5 shows a computing system 1000 including an exemplary configuration of a computing device 1001 for controlling the system liquid handling system 140 to thereby control movement of the pipetting head 130 (and thus, the apparatus 10) as disclosed herein.

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data 1007 (i.e., data provided by a system operator or generated by software that is executed by a processor) and/or program modules such as operating system 1005 and liquid handling system control software 1006 that are accessible to and/or are operated on by the one or more processors 1003. In exemplary aspects, the data 1007 can comprise: information about the dimensions and/or location of an apparatus 10 to be engaged by the pipetting head 130; information about the dimensions and/or location of a labware item 110 to be engaged by the apparatus 10; information about the location of the receptacle 150 (including, for example, a particular location within the receptacle where the labware item 110 is to be received); and/or information about the timing of lateral movement of the pipetting head (and apparatus) after the labware item 110 is received within the receptacle.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and tufting machine control software 1006 may be stored on the mass storage device 1004. One or more of the operating system 1005 and liquid handling system control software 1006 (or some combination thereof) may comprise program modules and the liquid handling system control software 1006. The data 1007 may also be stored on the mass storage device 1004. The data 1007 may be stored in any of one or more databases known in the art. The databases may be centralized or distributed across multiple locations within the network 1015.

A user may enter commands and information into the computing device 1001 using an input device (not shown). Such input devices comprise, but are not limited to, a keyboard, pointing device (e.g., a computer mouse, remote control), a touchscreen, a microphone, a joystick, a scanner, tactile input devices such as gloves, and other body coverings, motion sensor, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a,b,c. A remote computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computing device 1001 and a remote computing device 1014a,b,c may be made using a network 1015, such as a local area network (LAN) and/or a general wide area network (WAN). Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a,b,c can optionally have some or all of the components disclosed as being part of computing device 1001. In exemplary aspects, it is contemplated that the computing device 1001 can be provided as a component of a cloud-based network as is known in the art.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: An apparatus comprising: a body that is configured for complementary engagement with a pipetting head of a liquid handling system such that movement of the pipetting head effects a corresponding movement of the apparatus; a base that is coupled to the body, the base comprising at least one engagement feature that is configured to mechanically engage a surface of a labware item to releasably couple the labware item to the apparatus.

Aspect 2: The apparatus of aspect 1, wherein the body and the base are integrally formed as a monolithic structure.

Aspect 3: The apparatus of aspect 1, wherein the base is secured to the body by at least one fastener.

Aspect 4: The apparatus of any one of aspects 1-3, wherein the at least one engagement feature comprises a plurality of engagement features.

Aspect 5: The apparatus of aspect 4, wherein the plurality of engagement features are spaced along a transverse axis that is perpendicular to a vertical axis.

Aspect 6: The apparatus of aspect 5, wherein the plurality of engagement features comprise first and second plungers that are respectively biased to extend outwardly relative to first and second engagement axes that are perpendicular to the transverse axis.

Aspect 7: The apparatus of aspect 5, wherein the plurality of engagement features comprise first and second posts.

Aspect 8: The apparatus of aspect 5, wherein the plurality of engagement features comprise first and second latch elements.

Aspect 9: The apparatus of aspect 6, wherein the first and second plungers are respectively spring-loaded to extend outwardly along the first and second engagement axes.

Aspect 10: The apparatus of aspect 5 or aspect 9, wherein the base comprises first and second legs that receive respective portions of the first and second plungers.

Aspect 11: The apparatus of aspect 10, wherein the base further comprises at least one projection.

Aspect 12: The apparatus of aspect 11, wherein the at least one projection comprises first and second projections, wherein the first projection is spaced from and aligned with the first leg relative to the first engagement axis, and wherein the second projection is spaced from and aligned with the second leg relative to the second engagement axis.

Aspect 13: The apparatus of aspect 11, wherein the at least one projection is not intersected by the first or second engagement axes.

Aspect 14: The apparatus of any one of the preceding aspects, wherein the body defines a plurality of openings that are configured to receive a portion of a corresponding pipette structure of the pipetting head.

Aspect 15: The apparatus of aspect 14, wherein the plurality of openings comprises a plurality of rows of multiple openings, wherein the openings of each row of the plurality of rows are spaced apart relative to a transverse axis that is perpendicular to a vertical axis.

Aspect 16: The apparatus of any one of the preceding aspects, wherein the apparatus does not comprise a power source.

Aspect 17: The apparatus of any one of the preceding aspects, wherein the apparatus does not comprise an actuator.

Aspect 18: A system comprising: the apparatus of any one of aspects 1-17; and a labware item having at least one engagement feature that is complementary to and configured to releasably mechanically engage a corresponding engagement feature of the at least one engagement feature of the apparatus.

Aspect 19: The system of aspect 18, wherein the at least one engagement feature of the labware item comprises a plurality of engagement features spaced relative to a transverse axis that is perpendicular to a vertical axis.

Aspect 20: The system of aspect 18 or aspect 19, wherein the at least one engagement feature of the labware item comprises at least one recess defined in a surface of the labware item.

Aspect 21: The system of aspect 20, wherein the at least one engagement feature of the apparatus comprises at least one plunger, each plunger having a head, the head of each plunger having a shape that is complementary to a shape of a corresponding recess of the at least one recess of the labware item.

Aspect 22: The system of aspect 20, wherein the at least one engagement feature of the apparatus comprises at least one post, and wherein each recess of the at least one recess comprises a slot that is configured to receive a portion of a corresponding post.

Aspect 23: The system of aspect 18 or aspect 19, wherein the at least one engagement feature of the apparatus comprises at least one latch element, and wherein the at least one engagement feature of the labware item comprises a surface that is configured to contact a corresponding latch element of the at least one latch element.

Aspect 24: The system of any one of aspects 18-23, wherein the labware item has at least one release feature that is configured to releasably engage a corresponding engagement feature of the at least one engagement feature of the apparatus in response to translation of the apparatus relative to the labware item.

Aspect 25: The system of aspect 24, wherein the at least one release feature of the labware item comprises at least one groove defined within a surface of the labware item, wherein each groove of the at least one groove is spaced from a respective engagement feature of the at least one engagement feature of the labware item.

Aspect 26: The system of aspect 25, wherein each groove of the at least one groove has a variable width that increases moving in a direction such that a force of engagement between the at least one groove and the at least one engagement feature of the apparatus decreases as the apparatus is translated at least partially in the direction relative to the labware item.

Aspect 27: The system of any one of aspects 18-26, wherein the labware item has opposing first and second outer surfaces, wherein the at least one engagement feature of the labware item comprises at least one first engagement feature positioned along the first outer surface and at least one second engagement feature positioned along the second outer surface.

Aspect 28: The system of aspect 27, wherein each first engagement feature of the at least one first engagement feature is in alignment with a corresponding second engagement feature of the at least one second engagement feature relative to a respective engagement axis.

Aspect 29: The system of aspect 28, wherein the at least one first engagement feature comprises a plurality of first engagement features, and wherein the at least one second engagement feature comprises a plurality of second engagement features.

Aspect 30: The system of aspect 28 or aspect 29, wherein each engagement feature of the at least one engagement feature of the apparatus is configured to engage a respective first engagement feature of the labware item.

Aspect 31: The system of aspect 30, wherein the base of the apparatus comprises at least one leg, wherein each leg receives a portion of a respective engagement feature of the apparatus.

Aspect 32: The system of aspect 31, wherein the base further comprises at least one projection, wherein each projection is spaced from and aligned with a respective leg of the apparatus relative to a respective engagement axis.

Aspect 33: The system of aspect 32, wherein the at least one projection is not intersected by an engagement axis.

Aspect 34: The system of aspect 32 or aspect 33, wherein each projection of the at least one projection defines an engagement surface that is configured to engage a respective second engagement feature of the labware item.

Aspect 35: The system of aspect 34, wherein the labware item has a width relative to each respective engagement axis, and wherein at each respective engagement axis, the width of the labware item is less than a spacing between the projection and the leg of the apparatus that are aligned with the respective engagement axis, thereby permitting receipt of the labware item between the projection and the leg of the apparatus.

Aspect 36: The system of any one of aspects 18-35, wherein the labware item is an in-channel filter device.

Aspect 37: The system of any one of aspects 18-35, wherein the labware item is an electrode device.

Aspect 38: The system of any one of aspects 18-37, further comprising a pipetting head, wherein the body of the apparatus is configured for complementary engagement with the pipetting head such that movement of the pipetting head effects a corresponding movement of the apparatus.

Aspect 39: A method comprising: using a pipetting head of a liquid handling system to engage an apparatus of any one of aspects 1-17; using the pipetting head to position the apparatus relative to a labware item having at least one engagement feature that is complementary to a corresponding engagement feature of the at least one engagement feature of the apparatus, wherein the apparatus is positioned relative to the labware item such that at least one engagement feature of the apparatus releasably engages a corresponding engagement feature of the at least one engagement feature of the labware item; and with the apparatus releasably engaging the labware item, using the pipetting head to selectively move the apparatus and the labware item.

Aspect 40: The method of aspect 39, wherein the pipetting head translates relative to a translation axis to engage the apparatus, and wherein the at least one engagement feature of the labware item comprises a plurality of engagement features spaced relative to a transverse axis that is perpendicular to the translation axis.

Aspect 41: The method of aspect 39 or aspect 40, wherein the at least one engagement feature of the labware item comprises at least one recess defined in a surface of the labware item.

Aspect 42: The method of aspect 41, wherein the at least one engagement feature of the apparatus comprises at least one plunger, each plunger having a head, the head of each plunger having a shape that is complementary to a shape of a corresponding recess of the at least one recess of the labware item.

Aspect 43: The method of aspect 41, wherein the at least one engagement feature of the apparatus comprises at least one post, and wherein each recess of the at least one recess comprises a slot that receives a portion of a corresponding post.

Aspect 44: The system of aspect 39 or aspect 40, wherein the at least one engagement feature of the apparatus comprises at least one latch element, and wherein the at least one engagement feature of the labware item comprises a surface that contacts a corresponding latch element of the at least one latch element.

Aspect 45: The method of any one of aspects 39-44, further comprising: using the pipetting head to position the labware item within a receptacle that restricts movement of the labware item; and using the pipetting head to translate the apparatus relative to the labware item, wherein the labware item has at least one release feature that releasably engages a corresponding engagement feature of the at least one engagement feature of the apparatus in response to translation of the apparatus relative to the labware item.

Aspect 46: The method of aspect 45, wherein the at least one release feature of the labware item comprises at least one groove defined within a surface of the labware item, wherein each groove of the at least one groove is spaced from a respective engagement feature of the at least one engagement feature of the labware item.

Aspect 47: The method of aspect 46, further comprising: using the pipetting head to translate the apparatus in a direction relative to the labware item until the apparatus disengages the labware item, wherein each groove of the at least one groove has a variable width that increases moving at least partially in the direction such that a force of engagement between the at least one groove and the at least one engagement feature of the apparatus decreases as the apparatus is translated at least partially in the direction relative to the labware item.

Aspect 48: The method of aspect 47, further comprising: using the pipetting head to translate the apparatus to apply a force to the labware item to ensure that the labware item is fully received within the receptacle.

Aspect 49: The method of any one of aspects 39-48, wherein the labware item has opposing first and second outer surfaces, wherein the at least one engagement feature of the labware item comprises at least one first engagement feature positioned along the first outer surface and at least one second engagement feature positioned along the second outer surface.

Aspect 50: The method of aspect 49, wherein each first engagement feature of the at least one first engagement feature is in alignment with a corresponding second engagement feature of the at least one second engagement feature relative to a respective engagement axis.

Aspect 51: The method of aspect 50, wherein the at least one first engagement feature comprises a plurality of first engagement features, and wherein the at least one second engagement features comprises a plurality of second engagement features.

Aspect 52: The method of aspect 50 or aspect 51, wherein each engagement feature of the at least one engagement feature of the apparatus engages a respective first engagement feature of the labware item.

Aspect 53: The method of aspect 52, wherein the base of the apparatus comprises at least one leg, wherein each leg receives a portion of a respective engagement feature of the apparatus.

Aspect 54: The method of aspect 53, wherein the base further comprises at least one projection.

Aspect 55: The method of aspect 54, wherein the at least one projection comprises first and second projections, wherein each projection is spaced from and aligned with a respective leg of the apparatus relative to a respective engagement axis.

Aspect 56: The method of aspect 54, wherein the at least one projection is not intersected by an engagement axis.

Aspect 57: The method of any one of aspects 54-56, wherein each projection of the at least one projection defines an engagement surface that engages a respective second engagement feature of the labware item.

Aspect 58: The method of aspect 57, wherein the labware item has a width relative to each respective engagement axis, wherein at each respective engagement axis, the width of the labware item is less than a spacing between the projection and the leg of the apparatus that are aligned with the respective engagement axis, and wherein the labware item is received between the projection and the leg of the apparatus.

Aspect 59: The method of any one of aspects 39-58, wherein the labware item is an in-channel filter device.

Aspect 60: The method of any one of aspects 39-58, wherein the labware item is an electrode device.

Aspect 61: The apparatus of any one of aspects 1-17, wherein the base extends downwardly from the body.

Aspect 62: The system of aspect 24, wherein the at least one release feature is configured to releasably engage a corresponding engagement feature of the at least one engagement feature of the apparatus in response to lateral translation of the apparatus relative to the labware item.

Aspect 63: The system of aspect 62, wherein the at least one release feature of the labware item comprises at least one groove defined within a surface of the labware item, wherein each groove of the at least one groove is laterally spaced from a respective engagement feature of the at least one engagement feature of the labware item.

Aspect 64: The system of aspect 63, wherein each groove of the at least one groove has a variable width that increases moving in an upward or at least partially upward direction such that a force of engagement between the at least one groove and the at least one engagement feature of the apparatus decreases as the apparatus is translated in an upward or at least partially upward direction relative to the labware item.

Aspect 65: The method of any one of aspects 39-60, wherein the pipetting head positions the apparatus above the labware item and lowers the apparatus over the labware item such that at least one engagement feature of the apparatus releasably engages a corresponding engagement feature of the at least one engagement feature of the labware item.

Aspect 66: The method of aspect 65, wherein the pipetting head translates downwardly or at least partially downwardly relative to a vertical axis to engage the apparatus, and wherein the at least one engagement feature of the labware item comprises a plurality of engagement features spaced relative to a transverse axis that is perpendicular to the vertical axis.

Aspect 67: The method of aspect 45, wherein the labware item has at least one release feature that releasably engages a corresponding engagement feature of the at least one engagement feature of the apparatus in response to lateral translation of the apparatus relative to the labware item.

Aspect 68: The method of aspect 67, wherein the at least one release feature of the labware item comprises at least one groove defined within a surface of the labware item, wherein each groove of the at least one groove is laterally spaced from a respective engagement feature of the at least one engagement feature of the labware item.

Aspect 69: The method of aspect 68, further comprising: using the pipetting head to translate the apparatus in an upward or at least partially upward direction relative to the labware item until the apparatus disengages the labware item, wherein each groove of the at least one groove has a variable width that increases moving in an upward or at least partially upward direction such that a force of engagement between the at least one groove and the at least one engagement feature of the apparatus decreases as the apparatus is translated in the upward or at least partially upward direction relative to the labware item.

Aspect 70: The method of aspect 69, further comprising: using the pipetting head to translate the apparatus to apply a downward force to the labware item to ensure that the labware item is fully received within the receptacle.

Although several embodiments of the invention have been disclosed in the foregoing specification and the following appendices, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

1. An apparatus comprising:
a body that is configured for complementary engagement with a pipetting head of a liquid handling system such that movement of the pipetting head effects a corresponding movement of the apparatus;
a base that is coupled to the body, the base comprising at least one engagement feature that is configured to mechanically engage a surface of a labware item to releasably couple the labware item to the apparatus.

2. The apparatus of claim 1, wherein the body and the base are integrally formed as a monolithic structure.

3. The apparatus of claim 1, wherein the base is secured to the body by at least one fastener.

4. The apparatus of claim 1, wherein the at least one engagement feature comprises a plurality of engagement features.

5. The apparatus of claim 4, wherein the plurality of engagement features are spaced along a transverse axis that is perpendicular to a vertical axis.

6. The apparatus of claim 5, wherein the plurality of engagement features comprise first and second plungers that are respectively biased to extend outwardly relative to first and second engagement axes that are perpendicular to the transverse axis.

7. The apparatus of claim 5, wherein the plurality of engagement features comprise first and second posts.

8. The apparatus of claim 5, wherein the plurality of engagement features comprise first and second latch elements.

9. (canceled)

10. The apparatus of claim 5, wherein the base comprises first and second legs that receive respective portions of the first and second plungers.

11. The apparatus of claim 10, wherein the base further comprises at least one projection.

12. (canceled)

13. (canceled)

14. The apparatus of claim 1, wherein the body defines a plurality of openings that are configured to receive a portion of a corresponding pipette structure of the pipetting head.

15. (canceled)

16. (canceled)

17. (canceled)

18. A system comprising:
the apparatus of claim 1; and
a labware item having at least one engagement feature that is complementary to and configured to releasably mechanically engage a corresponding engagement feature of the at least one engagement feature of the apparatus.

19. The system of claim 18, wherein the at least one engagement feature of the labware item comprises a plurality of engagement features spaced relative to a transverse axis that is perpendicular to a vertical axis.

20. The system of claim 18, wherein the at least one engagement feature of the labware item comprises at least one recess defined in a surface of the labware item.

21. (canceled)

22. (canceled)

23. The system of claim 18, wherein the at least one engagement feature of the apparatus comprises at least one latch element, and wherein the at least one engagement feature of the labware item comprises a surface that is configured to contact a corresponding latch element of the at least one latch element.

24. The system of claim 18, wherein the labware item has at least one release feature that is configured to releasably engage a corresponding engagement feature of the at least one engagement feature of the apparatus in response to translation of the apparatus relative to the labware item.

25. The system of claim 24, wherein the at least one release feature of the labware item comprises at least one groove defined within a surface of the labware item, wherein each groove of the at least one groove is spaced from a respective engagement feature of the at least one engagement feature of the labware item.

26. (canceled)

27. The system of claim 18, wherein the labware item has opposing first and second outer surfaces, wherein the at least one engagement feature of the labware item comprises at least one first engagement feature positioned along the first outer surface and at least one second engagement feature positioned along the second outer surface.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. A method comprising:
using a pipetting head of a liquid handling system to engage an apparatus of claim 1;
using the pipetting head to position the apparatus relative to a labware item having at least one engagement feature that is complementary to a corresponding engagement feature of the at least one engagement feature of the apparatus, wherein the apparatus is positioned relative to the labware item such that at least one engagement feature of the apparatus releasably engages a corresponding engagement feature of the at least one engagement feature of the labware item; and
with the apparatus releasably engaging the labware item, using the pipetting head to selectively move the apparatus and the labware item.

40. The method of claim 39, wherein the pipetting head translates relative to a translation axis to engage the apparatus, and wherein the at least one engagement feature of the labware item comprises a plurality of engagement features spaced relative to a transverse axis that is perpendicular to the translation axis.

41. The method of claim 39, wherein the at least one engagement feature of the labware item comprises at least one recess defined in a surface of the labware item.

42. The method of claim 41, wherein the at least one engagement feature of the apparatus comprises at least one plunger, each plunger having a head, the head of each plunger having a shape that is complementary to a shape of a corresponding recess of the at least one recess of the labware item.

43. The method of claim 41, wherein the at least one engagement feature of the apparatus comprises at least one post, and wherein each recess of the at least one recess comprises a slot that receives a portion of a corresponding post.

44. The system of claim 39, wherein the at least one engagement feature of the apparatus comprises at least one latch element, and wherein the at least one engagement feature of the labware item comprises a surface that contacts a corresponding latch element of the at least one latch element.

45. The method of claim 39, further comprising:
using the pipetting head to position the labware item within a receptacle that restricts movement of the labware item; and
using the pipetting head to translate the apparatus relative to the labware item, wherein the labware item has at least one release feature that releasably engages a corresponding engagement feature of the at least one engagement feature of the apparatus in response to translation of the apparatus relative to the labware item.

46. The method of claim 45, wherein the at least one release feature of the labware item comprises at least one groove defined within a surface of the labware item, wherein each groove of the at least one groove is spaced from a respective engagement feature of the at least one engagement feature of the labware item.

47. (canceled)

48. (canceled)

49. The method of claim 39, wherein the labware item has opposing first and second outer surfaces, wherein the at least one engagement feature of the labware item comprises at least one first engagement feature positioned along the first outer surface and at least one second engagement feature positioned along the second outer surface.

50. (canceled)

51. (canceled)

52. (canceled)

53. (canceled)

54. (canceled)

55. (canceled)

56. (canceled)

57. (canceled)

58. (canceled)

59. The method of claim 39, wherein the labware item is an in-channel filter device.

60. (canceled)
